(19) United States
(12) Patent Application Publication
(10) Pub. No.: US 2026/0201091 A1
(43) Pub. Date: Jul. 16, 2026

(54) RESIN, RESIN COMPOSITION, CURED LAYER AND ETCHING METHOD

(71) Applicant: Advanced Echem Materials Company Limited, Taoyuan (TW)

(72) Inventors: Yu-Chen Chiu, Taoyuan (TW); Ting-Ruei Xu, Taoyuan (TW); Yun-Ju Chiang, Taoyuan (TW); Hsiang-Lin Hsu, Taoyuan (TW); Zhi-Jie Yang, Taoyuan (TW); Wei-Chung Liang, Taoyuan (TW); Cheng-Ying Hsieh, Taoyuan (TW)

(73) Assignee: Advanced Echem Materials Company Limited, Taoyuan (TW)

(21) Appl. No.: 19/433,969

(22) Filed: Dec. 29, 2025

(30) Foreign Application Priority Data
Jan. 15, 2025 (TW) 114101626

(51) Int. Cl. C08F 132/06; C08J 3/24; C08K 5/00; C08K 5/05; C08K 5/09; C08K 5/10; C08L 45/00

(52) U.S. Cl. CPC C08F 132/06; C08J 3/24; C08K 5/0008; C08K 5/05; C08K 5/09; C08K 5/10; C08L 45/00; C08J 2345/00

(57) ABSTRACT

A resin, a resin composition, a cured layer and an etching method are provided. The resin includes a structural unit represented by the following Formula (A). In the resin, an amount of the propynyl group is not zero. Among the hydrogen and the propynyl group represented by R¹ and R², a molar ratio of the hydrogen and the propynyl group is 90:10 to 55:45.

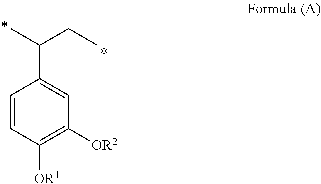

In Formula (A), R¹ and R² each represent hydrogen or propynyl group, and * represents a bonding position.

### CROSS-REFERENCE TO RELATED APPLICATION

This application claims the priority benefit of Taiwan application serial no. 114101626, filed on Jan. 15, 2025. The entirety of the above-mentioned patent application is hereby incorporated by reference herein and made a part of this specification.

### BACKGROUND

### Technical Field

The present invention relates to a resin, and particularly relates to a resin containing a propynyl group, a resin composition, a cured layer, and an etching method.

### Description of Related Art

With the development of semiconductor technology, in order to expand its application scope, the demand for reducing the critical dimensions of semiconductor devices has gradually increased. However, the thickness of the photoresist layer currently used for manufacturing semiconductor devices has become thinner, which may result in incomplete exposure during the process, thereby causing pattern collapse issues, and consequently affecting the performance of semiconductor devices manufactured using the same.

### SUMMARY

The invention provides a resin, a resin composition, a cured layer, and an etching method capable of forming good flatness and etching resistance.

The invention provides a resin. The resin includes a structural unit represented by the following Formula (A). In the resin, a content of the propynyl group is not zero. Among the hydrogen and a propynyl group represented by R¹ and R², a molar ratio of hydrogen to a propynyl group is 90:10 to 55:45.

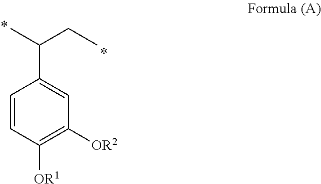

In Formula (A), R¹ and R² each represent hydrogen or a propynyl group, * represents a bonding position.

In an embodiment of the invention, a weight-average molecular weight (MW) of the resin is 1000 g/mol to 7000 g/mol.

In an embodiment of the invention, the structural unit represented by Formula (A) includes at least one of the structural units represented by the following Formulas (A-1) to (A-3):

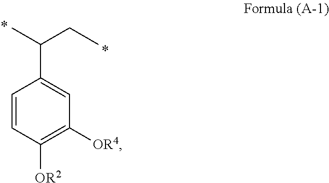

in Formula (A-1), R³ represents hydrogen, R⁴ represents a propynyl group;

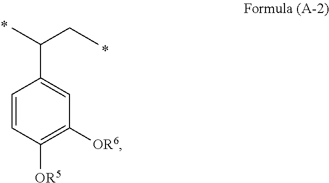

in Formula (A-2), R⁵ represents a propynyl group, R⁶ represents a propynyl group;

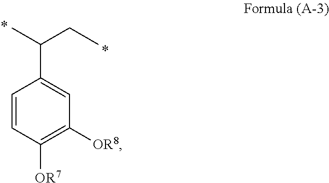

in Formula (A-3), R⁷ represents a propynyl group, R⁸ represents hydrogen.

In an embodiment of the invention, the resin further includes a structural unit represented by the following Formula (A-4):

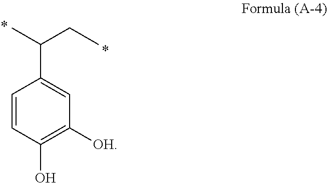

A resin composition of the invention includes a resin (A), a surfactant (B), and a solvent (C). The resin (A) is the resin described above. Based on a total usage amount of the resin composition being 100 parts by weight, a usage amount of the resin (A) is 1.5 parts by weight to 10 parts by weight, a usage amount of the surfactant (B) is 0.1 parts by weight to 5.0 parts by weight, and a usage amount of the solvent (C) is 80 parts by weight to 98.5 parts by weight.

In an embodiment of the invention, the surfactant (B) includes a fluorine-based surfactant or a polyoxyethylene ether-based surfactant. The fluorine-based surfactant further includes an alcohol group, an ester group, or a carboxyl group.

In an embodiment of the invention, the fluorine-based surfactant includes a compound represented by the following Formula (B-1):

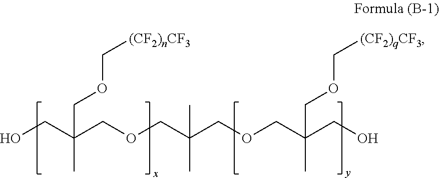

in Formula (B-1), a sum of x and y is an integer of 3 to 30, n represents an integer of 0 to 5, q represents an integer of 0 to 5.

In an embodiment of the invention, the polyoxyethylene ether-based surfactant includes a compound represented by the following Formula (B-2):

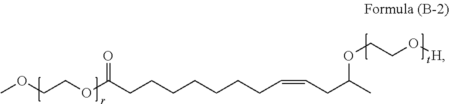

in Formula (B-2), r represents an integer of 0 to 15, t represents an integer of 0 to 15.

In an embodiment of the invention, the solvent (C) includes propylene glycol monomethyl ether, tetraethylene glycol dimethyl ether, propylene glycol monomethyl ether acetate, N,N-diethylformamide, isopropanol, methanol, acetone, n-butyl acetate, butanone, ethyl acetate, diacetone alcohol, or a combination thereof.

A cured layer of the invention is formed by curing the resin composition described above.

An etching method of the invention includes: immersing the cured layer described above in an etching solution to perform an etching process.

In an embodiment of the invention, the etching solution is an alkaline etching solution.

Based on the above, the resin of the invention includes a structural unit having a specific structure and containing a propynyl group. Thus, the resin composition including the specific resin may form a cured layer with good flatness and etching resistance, as well as an etching method.

To make the above-mentioned features and advantages of the present invention more evident and comprehensible, embodiments are described in detail below.

### DESCRIPTION OF THE EMBODIMENTS

### <Resin>

The invention provides a resin including a structural unit represented by the following Formula (A). In addition, the resin of the invention may include other suitable structural units according to needs.

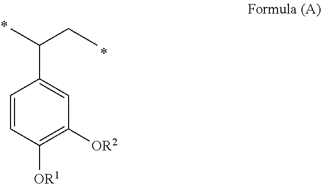

In Formula (A), R¹ and R² each represent hydrogen or a propynyl group, * represents a bonding position. The propynyl group may be *—CH₂—C≡CH or *—C≡C—CH₃, preferably *—CH₂—C≡CH. For example, in the structural unit represented by Formula (A), R¹ may represent hydrogen and R² represents a propynyl group; R¹ may represent a propynyl group and R² represents hydrogen; R¹ may represent a propynyl group and R² represents a propynyl group; or R¹ may represent hydrogen and R² represents hydrogen.

In the resin, a content of a propynyl group is not zero. For example, the resin may include a structural unit represented by Formula (A) where R¹ represents hydrogen and R² represents a propynyl group, and a structural unit represented by Formula (A) where R¹ represents hydrogen and R² represents hydrogen. In the resin, among the hydrogen and a propynyl group represented by R¹ and R², a molar ratio of hydrogen to a propynyl group may be 90:10 to 55:45, preferably 70:30 to 55:45. That is, based on a total of hydrogen and a propynyl group represented by R¹ and R² in the resin being 100%, a proportion of a propynyl group may be 10% to 45%, preferably 30% to 45%.

In this embodiment, the structural unit represented by Formula (A) may include at least one of the structural units represented by the following Formulas (A-1) to (A-3), and may further include the structural unit represented by the following Formula (A-4). The resin may include at least one of the structural units represented by Formulas (A-1) to (A-3), and may further include the structural unit represented by the following Formula (A-4).

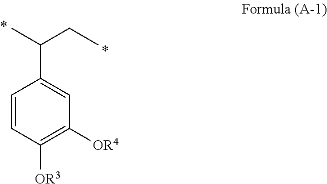

In Formula (A-1), R³ represents hydrogen, R⁴ represents a propynyl group.

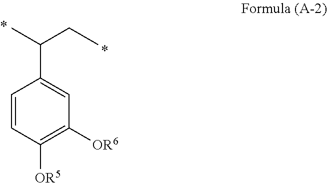

In Formula (A-2), R⁵ represents a propynyl group, R⁶ represents a propynyl group.

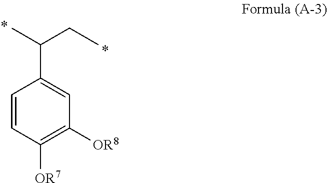

In Formula (A-3), R⁷ represents a propynyl group, R⁸ represents hydrogen.

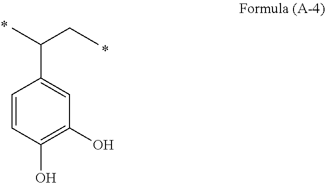

The resin may include a structure represented by the following Formula (A′), wherein m represents an integer of 7 to 50.

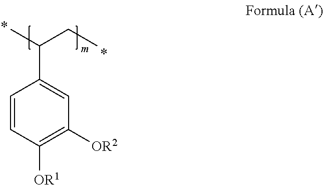

In Formula (A′), m represents an integer of 7 to 50, preferably an integer of 10 to 37. The definition of R¹ and R² in Formula (A′) are the same as that in Formula (A).

A weight average molecular weight of the resin may be about 1000 g/mol to about 7000 g/mol, preferably about 2000 g/mol to about 5000 g/mol.

### <Resin Composition>

The invention provides a resin composition including: a resin (A), a surfactant (B), and a solvent (C). In addition, the resin composition of the invention may include other suitable additives according to needs. The components are described hereinafter in detail.

### Resin (A)

The resin (A) is the resin described above including the structural unit represented by Formula (A). Based on a total usage amount of the resin composition being 100 parts by weight, a usage amount of the resin (A) is 1.5 parts by weight to 10 parts by weight, preferably 3 parts by weight to 6 parts by weight.

### Surfactant (B)

The surfactant (B) is not particularly limited, and any suitable surfactant may be selected according to needs. In this embodiment, the surfactant (B) may include a fluorine-based surfactant, a polyoxyethylene ether-based surfactant, or other suitable surfactants. The surfactant (B) may be used alone or in combination with multiple types.

The fluorine-based surfactant may further include an alcohol group, an ester group, a carboxyl group, a combination thereof, or other suitable functional groups. In this embodiment, the fluorine-based surfactant may include a compound represented by the following Formula (B-1) or other suitable fluorine-based surfactants including an alcohol group, an ester group, or a carboxyl group.

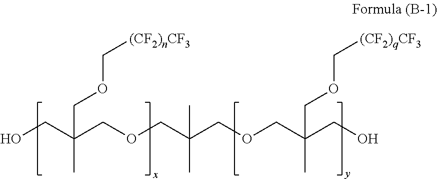

In Formula (B-1), a sum of x and y is an integer of 3 to 30, preferably an integer of 7 to 20;
n represents an integer of 0 to 5, preferably an integer of 1 to 3;
q represents an integer of 0 to 5, preferably an integer of 1 to 3.

In Formula (B-1), x may be an integer of 0 to 20, preferably an integer of 4 to 10, and y may be an integer of 0 to 20, preferably an integer of 4 to 10. At least one of x and y is not 0, preferably neither is 0.

The polyoxyethylene ether-based surfactant may include a compound represented by the following Formula (B-2) or other suitable polyoxyethylene ether-based surfactants.

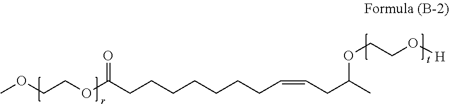

In Formula (B-2), r represents an integer of 0 to 15, preferably an integer of 1 to 8;
t represents an integer of 0 to 15, preferably an integer of 1 to 8. At least one of r and tis not 0, preferably neither is 0.

Based on a total usage amount of the resin composition being 100 parts by weight, a usage amount of the surfactant (B) is 0.1 parts by weight to 5.0 parts by weight, preferably 0.1 parts by weight to 1.0 part by weight.

### Solvent (C)

The solvent (C) is not particularly limited, and any suitable solvent may be selected according to needs. In this embodiment, the solvent (C) may include propylene glycol monomethyl ether, tetraethylene glycol dimethyl ether, propylene glycol monomethyl ether acetate, N,N-diethylformamide, isopropanol, methanol, acetone, n-butyl acetate, butanone, ethyl acetate, diacetone alcohol, a combination thereof, or other suitable solvents. The solvent (C) may be used alone or in combination with multiple solvents.

Based on a total usage amount of the resin composition being 100 parts by weight, a usage amount of the solvent (C) is 80 parts by weight to 98.5 parts by weight, preferably 89 parts by weight to 98.5 parts by weight.

When the resin composition includes the solvent (C), the resin composition may have an appropriate viscosity, thereby having good coating uniformity to form a cured layer.

### <Method for Preparing Resin Composition>

The method for preparing the resin composition is not particularly limited. For example, the resin (A), the surfactant (B), and the solvent (C) are placed in a mixer and stirred to uniformly mix them into a solution state. Other suitable additives may also be added if necessary. After mixing them uniformly, a liquid resin composition may be obtained.

### <Method for Manufacturing Cured Layer>

An exemplary embodiment of the invention provides a cured layer formed by curing the resin composition described above. In this embodiment, the cured layer may be an etching-resistant layer.

The cured layer may be formed by coating the resin composition described above on a substrate to form a coating film, and baking the coating film. For example, after coating the resin composition on the substrate to form a coating film, baking is performed at a temperature of 150° C. to 350° C. (preferably about 250° C.) for 1 minute to 10 minutes (preferably about 3 minutes) to form a cured layer with a thickness of 120 nm to 150 nm on the substrate.

The substrate is not particularly limited, but a material thereof is preferably silicon, silicon oxide, aluminum, aluminum oxide, copper, metal oxide, or metal nitride. The type of the substrate is not particularly limited, but may be a glass substrate, a plastic substrate material (for example, polyethersulfone (PES) plate, polycarbonate (PC) plate, or polyimide (PI) film), or other suitable substrate types.

The coating method is not particularly limited, but a spray coating method, a roll coating method, a vortex coating method, a screen printing method, a spin coating method, or the like may be used. In general, a spin coating method is widely used. In addition, after forming the coating film, in some cases, residual solvent may be partially removed under reduced pressure.

### <Etching Method>

An exemplary embodiment of the invention provides an etching method including immersing the cured layer described above in an etching solution to perform an etching process.

The etching solution is not particularly limited, and any suitable etching solution may be selected according to needs. In this embodiment, the etching solution is an alkaline etching solution. The alkaline etching solution may include ammonia water, hydrogen peroxide, water, tetramethylammonium hydroxide, potassium hydroxide, sodium hydroxide, ammonium chloride, copper chloride, or a combination thereof, preferably a combination of ammonia water, hydrogen peroxide, and water. When the alkaline etching solution is composed of ammonia water, hydrogen peroxide, and water, a mixing ratio (weight ratio) of ammonia water, hydrogen peroxide, and water may be 1:1:4 to 1:2:8, preferably 1:1:4 to 1:1:5.

Other steps included in the etching method may be steps known to those skilled in the art and are not further described herein.

The invention is described hereinafter in detail with reference to some examples. The following examples are provided to describe the invention, and the scope of the invention includes the categories described in the following claims, their equivalents, and their modifications. The invention is not limited to the scope of those examples.

### Synthesize Examples of Resin

Synthesis Examples 1 to 5 of the resin are described below:

### Synthesis Example 1

3,4-dihydroxystyrene (122.8 g) was added to ethyl acetate to prepare a 60% solid content 3,4-dihydroxystyrene ethyl acetate solution (204.7 g), then tetrahydrofuran (482 g) was added to the reaction flask, stirred at 10° C. for 10 minutes, followed by dropwise addition of a tetrahydrofuran solution containing 5% sulfuric acid (139.2 g), and transferred to room temperature to react for 50 hours. After the reaction was completed, a sample was taken and water (1156 g) was added to the reaction flask, followed by slowly adding sodium carbonate (57.34 g), tetrabutylammonium iodide (8.496 g), stirred at room temperature for 10 minutes, then 3-bromopropyne (53.65 g) was added, heated to reflux and reacted for 18.5 hours. After the reaction was completed, the reaction mixture was cooled and transferred to a separatory funnel, saturated brine was added for layer extraction. The aqueous layer was washed twice with ethyl acetate, then combined with the organic layers, and then the organic layer was washed three times with saturated brine. The organic layer was dehydrated with anhydrous magnesium sulfate, filtered to remove anhydrous magnesium sulfate, and the filtrate was concentrated and under vacuum system for 12 hours to obtain poly [3,4-dihydroxystyrene]-3-propynyl derivative A-1 (brown solid), sampled and confirmed by gel permeation chromatography for molecular weight (MW of about 3180 g/mol, MP of about 3608 g/mol, PDI of about 1.831), propynyl ratio: 9.2%.

### Synthesis Example 2

3,4-dihydroxystyrene (122.8 g) was added to ethyl acetate to prepare a 70% solid content 3,4-dihydroxystyrene ethyl acetate solution (197 g), then tetrahydrofuran (734 g) was added to the reaction flask, stirred at 10° C. for 10 minutes, followed by dropwise addition of a tetrahydrofuran solution containing 5% sulfuric acid (473.2 g), and transferred to room temperature to react for 40 hours. After the reaction was completed, a sample was taken and water (1404 g) was added to the reaction flask, followed by slowly adding sodium carbonate (96.73 g), tetrabutylammonium iodide (18.719 g), stirred at room temperature for 10 minutes, then 3-bromopropyne (108.56 g) was added, heated to reflux and reacted for 18 hours. After the reaction was completed, the reaction mixture was cooled and transferred to a separatory funnel, saturated brine was added for layer extraction. The aqueous layer was washed twice with ethyl acetate, then combined with the organic layers, and then the organic layer was washed three times with saturated brine. The organic layer was dehydrated with anhydrous magnesium sulfate, filtered to remove anhydrous magnesium sulfate, and the filtrate was concentrated and under vacuum system for 12 hours to obtain poly [3,4-dihydroxystyrene]-3-propynyl derivative A-2 (brown solid), sampled and confirmed by gel permeation chromatography for molecular weight (MW of about 2615 g/mol, MP of about 3118 g/mol, PDI of about 1.616), propynyl ratio: 32.3%.

### Synthesis Example 3

3,4-dihydroxystyrene (100 g) was added to ethyl acetate to prepare a 73% solid content 3,4-dihydroxystyrene ethyl acetate solution (137.0 g), then tetrahydrofuran (429 g) and dimethylacetamide (5.3 g) were added to the reaction flask, stirred at 10° C. for 10 minutes, followed by dropwise addition of a tetrahydrofuran solution containing 5% sulfuric acid (105.9 g), and transferred to room temperature to react for 59 hours. After the reaction was completed, a sample was taken and water (677.2 g) was added to the reaction flask, followed by slowly adding sodium carbonate (116.69 g), tetrabutylammonium iodide (5.422 g), stirred at room temperature for 10 minutes, then 3-bromopropyne (122.24 g) was added, heated to reflux and reacted for 18.5 hours. After the reaction was completed, the reaction mixture was cooled and transferred to a separatory funnel, saturated brine was added for layer extraction. The aqueous layer was washed twice with ethyl acetate, then combined with the organic layers, and then the organic layer was washed three times with saturated brine. The organic layer was dehydrated with anhydrous magnesium sulfate, filtered to remove anhydrous magnesium sulfate, and the filtrate was concentrated and under vacuum system for 12 hours to obtain poly [3,4-dihydroxystyrene]-3-propynyl derivative A-3 (brown solid), sampled and confirmed by gel permeation chromatography for molecular weight (MW of about 2996 g/mol, MP of about 3615 g/mol, PDI of about 1.921), propynyl ratio: 32.2%.

### Synthesis Example 4

3,4-dihydroxystyrene (100 g) was added to ethyl acetate to prepare a 73% solid content 3,4-dihydroxystyrene ethyl acetate solution (137 g), then tetrahydrofuran (429 g) and dimethylacetamide (5.3 g) were added to the reaction flask, followed by dropwise addition of a tetrahydrofuran solution containing 5% sulfuric acid (105.9 g), and transferred to room temperature to react for 59 hours. After the reaction was completed, a sample was taken and water (677.2 g) was added to the reaction flask, followed by slowly adding sodium carbonate (143.92 g), tetrabutylammonium iodide (5.422 g), 3-bromopropyne (152.80 g), heated to reflux and reacted for 18.5 hours. After the reaction was completed, saturated brine was added for layer extraction. The aqueous layer was washed twice with ethyl acetate, then combined with the organic layers, and then the organic layer was washed three times with saturated brine. The organic layer was dehydrated with anhydrous magnesium sulfate, filtered to remove anhydrous magnesium sulfate, and the filtrate was concentrated and under vacuum system for 12 hours to obtain prop-2-yn-1-yloxy hydroxyl type polystyrene resin A-4 (brown solid), sampled and confirmed by gel permeation chromatography for molecular weight (MW of about 3068 g/mol, MP of about 3693 g/mol, PDI of about 1.955), propynyl ratio: 36.7%.

### Synthesize Example 5

3,4-dihydroxystyrene (25 g) was added to ethyl acetate to prepare a 60% solid content 3,4-dihydroxystyrene ethyl acetate solution (41.7 g) and tetrahydrofuran (101.3 g) were added to the reaction flask, followed by dropwise addition of a tetrahydrofuran solution containing 5% sulfuric acid (25 g), and transferred to room temperature to react for 59 hours. After the reaction was completed, a sample was taken and water (168 g) was added to the reaction flask, followed by slowly adding sodium carbonate (34.13 g), tetrabutylammonium iodide (3.398 g), 3-bromopropyne (32.83 g), heated to reflux and reacted for 18 hours. After the reaction was completed, saturated brine was added for layer extraction. The aqueous layer was washed twice with ethyl acetate, then combined with the organic layers, and then the organic layer was washed three times with saturated brine. The organic layer was dehydrated with anhydrous magnesium sulfate, filtered to remove anhydrous magnesium sulfate, and the filtrate was concentrated and under vacuum system for 12 hours to obtain prop-2-yn-1-yloxy hydroxyl type polystyrene resin A-5 (brown solid), sampled and confirmed by gel permeation chromatography for molecular weight (MW of about 4056 g/mol, MP of about 4619 g/mol, PDI of about 1.975), propynyl ratio: 43.6%.

### Examples of Resin Composition and Cured Layer

Example 1 to Example 7 and Comparative Example 1 to Comparative Example 8 of the resin composition and the cured layer are described below:

### Example 1

a. Resin Composition

4.4 parts by weight of resin A-2 and 0.1 parts by weight of surfactant B-1 were added to a mixed solvent of 90.75 parts by weight of PM and 4.75 parts by weight of TEGDE, and after stirring uniformly with a stirrer, the resin composition of Example 1 was obtained.

b. Cured Layer

Each resin composition obtained in the Examples was coated on a substrate (e.g., an 8-inch silicon substrate) by a spin coating method (spin coater model: MK-8, manufactured by Tokyo Electron Ltd. (TEL), with a rotation speed of about 1500 rpm). Then, baking was performed at a temperature of 250° C. for 3 minutes to form a cured layer with a thickness of 150 nm. The obtained cured layer was evaluated by each of the following evaluation methods, and the results thereof are shown in Table 2.

### Example 2 to Example 7 and Comparative Example 1 to Comparative Example 8

The resin compositions of Example 2 to Example 7 and Comparative Example 1 to Comparative Example 8 were prepared using the same steps as Example 1, and the difference thereof is: the types of components and their usage amounts in the resin composition were changed (as shown in Table 2), wherein the components/compounds corresponding to the labels in Table 2 are shown in Table 1. The obtained resin compositions were made into cured layers and evaluated by each of the following evaluation methods, and the results are shown in Table 2. In Table 2, those with flatness less than 30 Å and etching resistance less than 10 Å are listed as Examples; those not within the aforementioned range are listed as Comparative Examples.

TABLE 1

| | La- | |
|---|---|---|
| | bel | Components/compounds |
| Resin | A-1 | Resin A-1 obtained from Synthesis Example 1, including |
| (A) | | a structural unit represented by Formula (A′), wherein |
| | | among the hydrogen and a propynyl group represented by |
| | | R¹ and R², the molar ratio of hydrogen |
| | | to a propynyl group is 90.8:9.2. |
| | | The weight average molecular weight is about 3180 |
| | | g/mol. |
| | A-2 | Resin A-2 obtained from Synthesis Example 2, including |
| | | a structural unit represented by Formula (A′), wherein |
| | | among the hydrogen and a propynyl group represented by |
| | | R¹ and R², the molar ratio of hydrogen |
| | | to a propynyl group is 67.7:32.3. |
| | | The weight average molecular weight is about 2615 |
| | | g/mol. |
| | A-3 | Resin A-3 obtained from Synthesis Example 3, including |
| | | a structural unit represented by Formula (A′), wherein |
| | | among the hydrogen and a propynyl group represented by |
| | | R¹ and R², the molar ratio of hydrogen |
| | | to a propynyl group is 67.8:32.2. |
| | | The weight average molecular weight is about 2996 |
| | | g/mol. |
| | A-4 | Resin A-4 obtained from Synthesis Example 4, including |
| | | a structural unit represented by Formula (A′), wherein |
| | | among the hydrogen and a propynyl group represented by |
| | | R¹ and R², the molar ratio of hydrogen |
| | | to a propynyl group is 63.3:36.7. |
| | | The weight average molecular weight is about 3068 |
| | | g/mol. |
| | A-5 | Resin A-5 obtained from Synthesis Example 5, including |
| | | a structural unit represented by Formula (A′), wherein |
| | | among the hydrogen and a propynyl group represented by |
| | | R¹ and R², the molar ratio of hydrogen |
| | | to a propynyl group is 56.4:43.6. |
| | | The weight average molecular weight is about 4056 |
| | | g/mol. |
| Surfac- | B-1 | Fluorine-based surfactant represented by Formula (B-1), |
| tant | | wherein n represents an integer of 1 to 3, q represents an |
| (B) | | integer of 1 to 3, and the sum of x and y is an integer |
| | | of 7 to 20. |
| | B-2 | Polyoxyethylene ether-based surfactant represented by |
| | | Formula (B-2), wherein r represents an integer of 2 to 8, |
| | | and t represents an integer of 2 to 8. |
| | B-3 | Fluorine-based surfactant represented by Formula (B-1), |
| | | wherein n represents 1, q represents 1, and the sum of |
| | | x and y is an integer of 7 to 19. |
| Solvent | C-1 | Propylene glycol monomethyl ether (PM) |
| (C) | C-2 | Tetraethylene glycol dimethyl ether (TEGDE) |
| Cross- | D-1 | 2-Allylphenol |
| linking | D-2 | Naphthol-type epoxy resin |
| agent | D-3 | Dipentaerythritol pentaacrylate |
| (D) | D-4 | Acrylic ester type resin |
| | D-5 | Catechin |

TABLE 2

| Component | | Examples | | | | | | |
|---|---|---|---|---|---|---|---|---|
| (unit: parts by weight) | | 1 | 2 | 3 | 4 | 5 | 6 | 7 |
| Resin (A) | A-1 | — | — | — | — | — | — | — |
| | A-2 | 4.4 | — | — | — | — | — | — |
| | A-3 | — | 4.4 | — | — | 4.4 | 4.4 | 10 |
| | A-4 | — | — | 4.4 | — | — | — | — |
| | A-5 | — | — | — | 4.4 | — | — | — |
| Surfactant | B-1 | 0.1 | 0.1 | 0.1 | 0.1 | — | — | 0.1 |
| (B) | B-2 | — | — | — | — | 0.1 | — | — |
| | B-3 | — | — | — | — | — | 0.1 | — |
| Solvent (C) | C-1 | 90.75 | 90.75 | 90.75 | 90.75 | 90.75 | 90.75 | 85.4 |
| | C-2 | 4.75 | 4.75 | 4.75 | 4.75 | 4.75 | 4.75 | 4.5 |
| Crosslinking | D-1 | — | — | — | — | — | — | — |
| agent (D) | D-2 | — | — | — | — | — | — | — |
| | D-3 | — | — | — | — | — | — | — |
| | D-4 | — | — | — | — | — | — | — |
| | D-5 | — | — | — | — | — | — | — |
| Evaluate | Flatness (Å) | 22.0 | 24.0 | 13.0 | 14.0 | 18.0 | 20.0 | 25.0 |
| results | Etching | 5.2 | 5.0 | 3.3 | 8.8 | 4.0 | 5.0 | 6.0 |
| | resistance | | | | | | | |
| | (Å) | | | | | | | |

| Component | | Comparative Examples | | | | | | | |
|---|---|---|---|---|---|---|---|---|---|
| (unit: parts by weight) | | 1 | 2 | 3 | 4 | 5 | 6 | 7 | 8 |
| Resin (A) | A-1 | 4.4 | — | — | — | — | — | | — |
| | A-2 | — | — | — | — | — | — | | — |
| | A-3 | — | 4.5 | 2.64 | 2.64 | 3.52 | 3.52 | 4.4 | 20 |
| | A-4 | — | — | — | — | — | — | — | — |
| | A-5 | — | — | — | — | — | — | — | — |
| Surfactant | B-1 | 0.1 | — | 0.1 | 0.1 | 0.1 | 0.1 | 0.1 | 0.1 |
| (B) | B-2 | — | — | — | — | — | — | — | — |
| | B-3 | — | — | — | — | — | — | — | — |
| Solvent (C) | C-1 | 90.75 | 90.75 | 90.75 | 90.75 | 90.75 | 90.75 | 90.5 | 75.9 |
| | C-2 | 4.75 | 4.75 | 4.75 | 4.75 | 4.75 | 4.75 | 4.5 | 4.0 |
| Crosslinking | D-1 | — | — | 1.76 | — | — | — | — | — |
| agent (D) | D-2 | — | — | — | 1.76 | — | — | — | — |
| | D-3 | — | — | — | — | 0.88 | — | — | — |
| | D-4 | — | — | — | — | — | 0.88 | — | — |
| | D-5 | — | — | — | — | — | — | 0.5 | — |
| Evaluate | Flatness | 27.0 | 35.0 | 9.0 | 33.0 | 46.0 | 20.0 | 5.0 | 45.0 |
| result | (Å) | | | | | | | | |
| | Etching | 18.7 | 15.0 | 94.5 | 42.5 | 25.1 | *Peel | *Peel | 7.0 |
| | resistance | | | | | | off | off | |
| | (Å) | | | | | | | | |

*Peel off: The cured layer was peeled off from the substrate within 30 minutes during the etching resistance test.

### 5<Evaluation Methods>

a. Flatness

The prepared resin compositions were respectively coated on 8-inch silicon substrates, baked and cured to form cured layers, and then the Cauchy parameters of the formulations were detected by an Ellipsometer. The parameters were then applied to an optical film thickness meter (Optical film thickness, model: DNS VM-1210, manufactured by SCREEN SPE Co., Ltd.) to measure the film thickness at 69 different points on the film surface. The film thickness difference was obtained by subtracting the minimum value from the maximum value of the film thickness. When the film thickness difference is smaller, the cured layer has good flatness, i.e., good uniformity.

b. Etching Resistance

The prepared resin compositions were respectively coated on 8-inch silicon substrates, baked and cured to form cured layers, and then immersed in an alkaline etching solution (ammonia water:hydrogen peroxide:water=150:150:700 (weight ratio)) at room temperature (25° C.). After immersion for 30 minutes, the change in film thickness was measured. When the change in film thickness is smaller, the cured layer has good etching resistance, i.e., good alkali resistance.

### <Evaluation Results>

As shown in Table 2, the cured layers formed from the Examples of the resin composition for which the resin composition includes the resin (A) with a structural unit having specific structure and containing a propynyl group have good flatness and etching resistance, and may be suitable for semiconductor processes. In contrast, the cured layers formed from the Comparative Examples of the resin composition for which the resin composition lacks the resin (A) with a structural unit having specific structure and containing a propynyl group exhibit poor flatness and/or etching resistance.

In addition, as shown in Table 2, compared to the cured layer prepared from the resin composition for which the molar ratio of hydrogen and a propynyl group represented by R¹ and R² in the resin (A) is not within the range of 90:10 to 55:45 (Comparative Example 1), the cured layers prepared from the resin compositions for which the molar ratio of hydrogen and a propynyl group represented by R¹ and R² in the resin (A) is within the range of 90:10 to 55:45 (Examples 1 to 7) have smaller film thickness differences and film thickness changes, i.e., better flatness and etching resistance. Therefore, when the molar ratio of hydrogen and a propynyl group represented by R¹ and R² in the resin (A) is within the range of 90:10 to 55:45, the cured layer formed from the resin composition including the resin (A) may have better flatness and etching resistance.

In addition, as shown in Table 2, compared to the cured layer prepared from the resin composition lacking the surfactant (B) (Comparative Example 2), the cured layers prepared from the resin compositions including the surfactant (B) (Examples 1 to 7) have smaller film thickness differences and film thickness changes, i.e., better flatness and etching resistance. Therefore, when the resin composition includes the surfactant (B) with different structures, the cured layer formed from the resin composition may have better flatness and etching resistance.

In addition, as shown in Table 2, in the case where the resin compositions are composed of the same components, compared to the cured layer prepared from the resin composition lacking the surfactant (B) (Comparative Example 2), the cured layers prepared from the resin compositions including the surfactant (B) (Examples 2, 5 and 6) have smaller film thickness differences and film thickness changes, i.e., better flatness and etching resistance. Therefore, when the resin composition includes the surfactant (B) with different structures, the cured layer formed from the resin composition may have better flatness and etching resistance.

In addition, as shown in Table 2, compared to the cured layers prepared from the resin compositions including the crosslinking agent (D) (Comparative Examples 3 to 7), the cured layers prepared from the resin compositions lacking the crosslinking agent (D) (Examples 1 to 7) have better etching resistance. Therefore, when the resin composition includes the resin (A) having a structural unit having specific structure and containing a propynyl group, and lacks the crosslinking agent (D), the cured layer formed from the resin composition may have better etching resistance.

In addition, as shown in Table 2, in the case where the only difference in the components composing the resin compositions is the crosslinking agent (D), compared to the cured layers prepared from the resin compositions including the crosslinking agent (D) (Comparative Examples 3 to 7), the cured layer prepared from the resin composition lacking the crosslinking agent (D) (Example 2) has better etching resistance. Therefore, when the resin composition includes the resin (A) having a structural unit having specific structure and containing a propynyl group, and lacks the crosslinking agent (D), the cured layer formed from the resin composition may have better etching resistance.

In addition, as shown in Table 2, compared to the cured layer prepared from the resin composition for which the usage amount of the resin (A) is not within the range of 1.5 parts by weight to 10 parts by weight based on a total usage amount of the resin composition being 100 parts by weight (Comparative Example 8), the cured layers prepared from the resin compositions for which the usage amount of the resin (A) is within the range of 1.5 parts by weight to 10 parts by weight (Examples 1 to 7) have smaller film thickness differences, i.e., better flatness, while also have good etching resistance. Therefore, when the usage amount of the resin (A) in the resin composition is within the range of 1.5 parts by weight to 10 parts by weight, the cured layer formed from the resin composition may have better flatness and good etching resistance.

In addition, as shown in Table 2, in the case where the resin compositions are composed of the same components, compared to the cured layer prepared from the resin composition for which the usage amount of the resin (A) is not within the range of 1.5 parts by weight to 10 parts by weight based on a total usage amount of the resin composition being 100 parts by weight (Comparative Example 8), the cured layers prepared from the resin compositions for which the usage amount of the resin (A) is within the range of 1.5 parts by weight to 10 parts by weight (Examples 2 and 7) have smaller film thickness differences, i.e., better flatness, while also have good etching resistance. Therefore, when the usage amount of the resin (A) in the resin composition is within the range of 1.5 parts by weight to 10 parts by weight, the cured layer formed from the resin composition may have better flatness and good etching resistance.

In summary, the resin composition of the invention includes the resin (A) having a structural unit with specific structure and containing a propynyl group, and when the molar ratio of hydrogen to a propynyl group is 90:10 to 55:45 among the hydrogen and a propynyl group represented by R¹ and R², the cured layers formed from the resin composition have good flatness and etching resistance, and make it applicable to semiconductor processes, thereby improving the performance of semiconductor devices manufactured using the same.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A resin, comprising a structural unit represented by the following Formula (A): 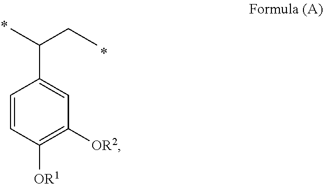
in Formula (A), R¹ and R² each represent hydrogen or a propynyl group, * represents a bonding position,
wherein in the resin, a content of the propynyl group is not 0,
among the hydrogen and the propynyl group represented by R¹ and R², a molar ratio of hydrogen to a propynyl group is 90:10 to 55:45.

2. The resin according to claim 1, wherein a weight average molecular weight of the resin is 1000 g/mol to 7000 g/mol.

3. The resin according to claim 1, wherein the structural unit represented by Formula (A) comprises at least one of the structural units represented by the following Formulas (A-1) to (A-3): 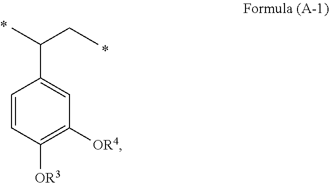
in Formula (A-1), R³ represents hydrogen, R⁴ represents a propynyl group; 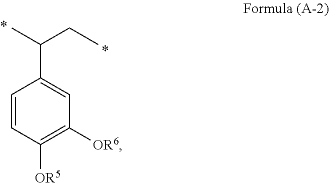
in Formula (A-2), R⁵ represents a propynyl group, R⁶ represents a propynyl group; 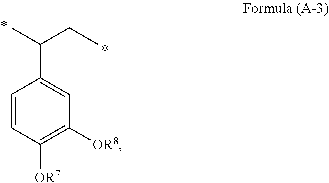
in Formula (A-3), R⁷ represents a propynyl group, R⁸ represents hydrogen.

4. The resin according to claim 3, further comprising a structural unit represented by the following Formula (A-4):

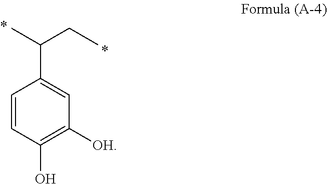

5. A resin composition, comprising:
a resin (A), which is the resin according to claim 1;
a surfactant (B); and
a solvent (C),
wherein based on a total usage amount of the resin composition being 100 parts by weight, a usage amount of the resin (A) is 1.5 parts by weight to 10 parts by weight, a usage amount of the surfactant (B) is 0.1 parts by weight to 5.0 parts by weight, and a usage amount of the solvent (C) is 80 parts by weight to 98.5 parts by weight.

6. The resin composition according to claim 5, wherein the surfactant (B) comprises a fluorine-based surfactant or a polyoxyethylene ether-based surfactant, the fluorine-based surfactant further comprises an alcohol group, an ester group, or a carboxyl group.

7. The resin composition according to claim 6, wherein the fluorine-based surfactant comprises a compound represented by the following Formula (B-1): 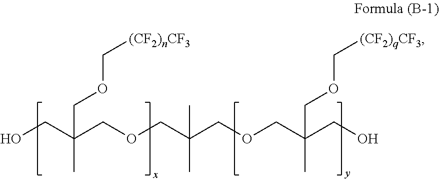
in Formula (B-1), a sum of x and y is an integer of 3 to 30, n represents an integer of 0 to 5, q represents an integer of 0 to 5.

8. The resin composition according to claim 6, wherein the polyoxyethylene ether-based surfactant comprises a compound represented by the following Formula (B-2): 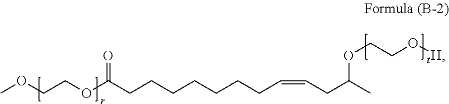
in Formula (B-2), r represents an integer of 0 to 15, t represents an integer of 0 to 15.

9. The resin composition according to claim 5, wherein the solvent (C) comprises propylene glycol monomethyl ether, tetraethylene glycol dimethyl ether, propylene glycol monomethyl ether acetate, N,N-diethylformamide, isopropanol, methanol, acetone, n-butyl acetate, butanone, ethyl acetate, diacetone alcohol, or a combination thereof.

10. A cured layer formed by curing the resin composition according to claim 5.

11. An etching method, comprising: immersing the cured layer according to claim 10 in an etching solution to perform an etching process.

12. The etching method according to claim 11, wherein the etching solution is an alkaline etching solution.
